(19) United States
(12) Patent Application Publication
(10) Pub. No.: US 2014/0297193 A1
(43) Pub. Date: Oct. 2, 2014

(54) SEISMIC METHODS AND SYSTEMS EMPLOYING SHALLOW SHEAR-WAVE SPLITTING ANALYSIS USING RECEIVER FUNCTIONS

(71) Applicant: CGG SERVICES SA, Massy Cedex (FR)

(72) Inventors: Bruce MATTOCKS, Katy, TX (US); Kristof DE MEERSMAN, Calgary, Alberta (CA)

(73) Assignee: CGG SERVICES SA, Massy Cedex (FR)

(21) Appl. No.: 14/224,310

(22) Filed: Mar. 25, 2014

Related U.S. Application Data
(60) Provisional application No. 61/805,262, filed on Mar. 26, 2013.

(51) Int. Cl. G01V 1/36

(52) U.S. Cl. CPC G01V 1/362
USPC 702/17

(57) ABSTRACT

Methods and systems for shallow shear-wave splitting analysis using receiver functions of seismic data are described. Radial and transverse receiver functions are calculating by, for example, performing cross-correlations of vertical component data with radial component data and vertical component data with transverse component data, respectively. The receiver functions are then used to determine orientation and other characteristics associated with shear waves passing through an azimuthally anisotropic layer.

### RELATED APPLICATION

The present application is related to, and claims priority from U.S. Provisional Patent Application No. 61/805,262, filed Mar. 26, 2013, entitled “SHALLOW SHEAR-WAVE SPLITTING ANALYSIS USING RECEIVER FUNCTIONS,” to Bruce MATTOCKS and Kristof DE MEERSMAN, the disclosure of which is incorporated herein by reference.

### TECHNICAL FIELD

Embodiments of the subject matter disclosed herein generally relate to methods and systems for seismic data processing and, more particularly, to mechanisms and techniques for shallow shear-wave splitting analysis.

### BACKGROUND

Seismic data acquisition and processing techniques are used to generate a profile (image) of a geophysical structure (subsurface) of the strata underlying the land surface or seafloor. Among other things, seismic data acquisition involves the generation of acoustic waves and the collection of reflected/refracted versions of those acoustic waves to generate the image. This image does not necessarily provide an accurate location for oil and gas reservoirs, but it may suggest, to those trained in the field, the presence or absence of oil and/or gas reservoirs. Thus, providing an improved image of the subsurface in a shorter period of time is an ongoing process in the field of seismic surveying or exploration.

Receiver functions are often used in earthquake seismology to infer the depth of major crustal boundaries, e.g., the boundary between the crust and the mantle, i.e., the Moho. As will be appreciated by those skilled in the art, receiver functions can be expressed as time series, computed from three-component seismograms, which show the relative response of the Earth's structure near the receiver based on a received waveform. The waveform is a composite of P-to-S converted waves that reverberate in the structure beneath the seismometer. For instance, when a primary or pressure wave (P-wave) transmits through a boundary between layers in the subsurface, part of the P-wave energy is converted to an secondary or shear wave (S-wave). The time delay that is associated with the recording the P-wave on the vertical component and the S-wave on the radial component can be used to determine the depth to the wave converting boundary.

Unlike earthquake seismology, however, receiver functions are rarely computed for seismic data acquired as part of a seismic survey and are even more infrequently used to generate a profile of a geophysical structure. This fact is unfortunate because receiver functions can be of particular use in the processing of converted wave data, i.e., receiver functions can provide valuable information on the near-surface S-wave velocity structure and accordingly, on statics, as evidenced in publications by, for example, K. De Meersman and M. Roizman in their 2009 article entitled “Converted Wave Receiver Statics from First Break Mode Conversions,” published in “Frontiers+Innovation,” 2009 CSPG CSEG CWLS Convention, pages 219-222, incorporated herein by reference, and by D. van Manen, J. Robertsson, A. Curtis, R. Ferber and H. Paulssen in their 2002 article entitled “Shear-Waves Statics Using Receiver Functions,” published in the 72nd Annual International Meeting, SEG Expanded Abstracts 21, page 1412, incorporated herein by reference.

Accordingly, it would be desirable to provide seismic data processing systems and methods that avoid the afore-described problems and drawbacks, and which use receiver functions to provide valuable information about near surface azimuthal anisotropy.

### SUMMARY

Thus, according to embodiments, methods and systems for shallow shear-wave splitting analysis using receiver functions of seismic data are described. Radial and transverse receiver functions are calculating by, for example, performing cross-correlations of vertical component data with radial component data and vertical component data with transverse component data, respectively. The receiver functions are then used to determine orientation and other characteristics associated with shear waves passing through an azimuthally anisotropic layer.

According to an embodiment, a method for removing one or more effects, associated with anisotropy in a near surface layer, in acquired seismic data includes determining an orientation of a fast shear wave in the near surface using receiver functions, and removing the one or more effects associated with anisotropy in the near surface layer using the determined orientation.

According to another embodiment, a system for removing one or more effects, associated with anisotropy in a near surface layer, in acquired seismic data includes at least one processor configured to determine an orientation of a fast shear wave in the near surface using receiver functions; and to remove the one or more effects associated with anisotropy in the near surface layer using the determined orientation.

According to another embodiment, a method for determining characteristics of fast and slow shear waves propagating through an anisotropic layer includes the steps of removing effects of geometrical spreading in acquired seismic data, calculating radial and transverse receiver functions using the acquired seismic data, sorting the radial and transverse receiver functions by azimuth, determining an orientation of a symmetry plane associated with a fast shear wave; and determining an isotropy axis and a symmetry axis based upon the orientation.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 shows various aspects of an onshore seismic data acquisition system whose acquired data can be processed in accordance with the embodiments;

FIG. 2 depicts a P-wave travelling through various layers as part of a seismic acquisition process;

FIG. 3 shows the P-wave of FIG. 2 being converted to an S-wave;

FIG. 4 shows the P-wave of FIG. 2 being converted into two S-waves in the presence of anisotropy in one of the layers;

FIG. 5 is a top or plan view of a source generating waves received by multi-component detectors;

FIG. 6 shows the generation of two S-waves due to anisotropy in the context of the system of FIG. 5;

FIG. 7 shows the interaction between the two S-waves of FIG. 6 and the radial component of the detectors;

FIG. 8 shows the interaction between the two S-waves of FIG. 6 and the transverse component of the detectors;

FIGS. 9 and 10 show different views of a seismic acquisition system used to generate a synthetic seismic dataset;

FIGS. 11(a) and 11(b) show vertical component data and radial component data, respectively, for a cross-section of a volume of seismic data recorded by the system of FIGS. 9 and 10 when a shallow layer of interest is isotropic;

FIGS. 12(a)-12(c) show vertical component data, radial component data, and transverse component data, respectively, for a cross-section of a volume of seismic data recorded by the system of FIGS. 9 and 10 when a shallow layer of interest is anisotropic;

FIGS. 13(a) and 13(b) show vertical component data and radial component data, respectively, for a cross-section of a volume of seismic data recorded by the system of FIGS. 9 and 10 when a shallow layer of interest is isotropic and after performing a linear moveout process thereto;

FIGS. 14(a)-14(c) show vertical component data, radial component data, and transverse component data, respectively, for a cross-section of a volume of seismic data recorded by the system of FIGS. 9 and 10 when a shallow layer of interest is anisotropic and after performing a linear moveout process thereto;

FIGS. 15(a) and 15(b) show receiver functions according to an embodiment;

FIGS. 16(a) and 16(b) show the receiver functions of FIGS. 15(a) and 15(b), respectively, with the axes of the slow and fast shear waves marked accordingly;

FIGS. 17(a) and 18 are flowcharts illustrating methods according to embodiments;

FIGS. 17(b) and 17(c) show radial and transverse component data, respectively, after the application of the method of FIG. 17(a) thereto; and

FIG. 19 is a computing device which can be used to implement embodiments.

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to the terminology and structure of shallow shear-wave splitting analysis using receiver functions. However, the embodiments to be discussed next are not limited to these configurations, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

As mentioned above, embodiments described herein take advantage of receiver functions to enhance seismic data processing techniques. More specifically, embodiments make determinations about the anisotropy associated with a subsurface being imaged by, for example, computing a plurality of receiver functions based on refracted energy and generating information associated with near-surface azimuthal anisotropy based on the receiver functions.

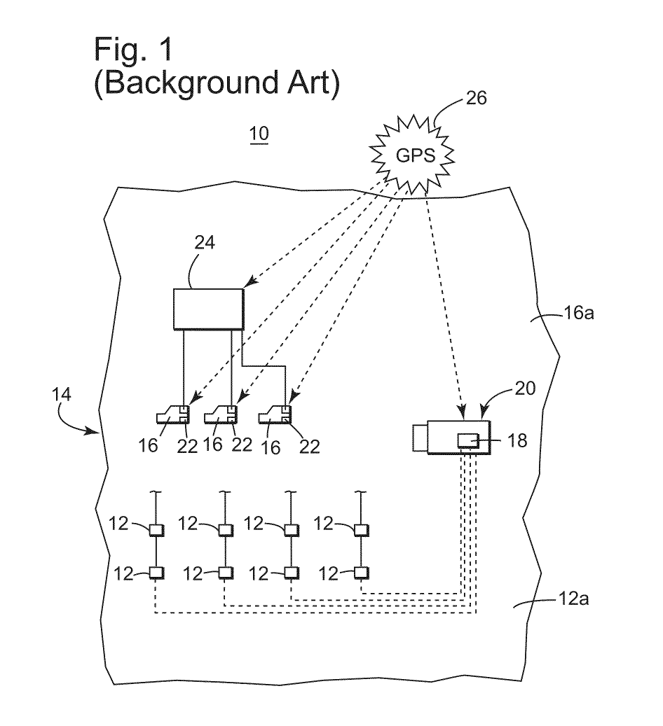

Prior to discussing such embodiments in detail, and in order to provide some context for the subsequent embodiments for shallow shear-wave splitting analysis using receiver functions, consider first a seismic data acquisition process and system in which such embodiments can be employed as will now be described with respect to FIG. 1.

A configuration for seismic acquisition in a land environment is illustrated in FIG. 1. The system 10 includes plural receivers 12 positioned over an area 12a of a subsurface to be explored and in contact with the surface 14 of the ground. The receivers 12 may, for example, be three-component (3C) geophones or 4C, i.e., a 3C geophone and a hydrophone, or may have more components. A number of sources 16 are also placed on the surface 14 in an area 16a, in a vicinity of the area 12a of the receivers 12. A recording device 18 is connected to the plurality of receivers 12 and placed, for example, in a station-truck 20. Each source 16 may be composed of a variable number of vibrators, typically between 1 and 5, and may include a local controller 22. A central controller 24 may be present to coordinate the shooting times of the sources 16. A GPS system 26 may be used to time-correlate the sources 16 and the receivers 12.

With this configuration, sources 16 are controlled to generate seismic waves, and the plurality of receivers 12 records waves reflected by the oil and/or gas reservoirs and other structures. The seismic survey may be repeated at various time intervals, e.g., months or years apart, to determine changes in the reservoirs. Although repeatability of source and receiver locations is generally easier to achieve onshore, the variations caused by changes in near-surface can be significantly larger than reservoir fluid displacement, making time-lapse 4D seismic acquisition and repeatability challenging. Thus, variations in seismic velocity in the near-surface are a factor that impacts repeatability of 4D surveys.

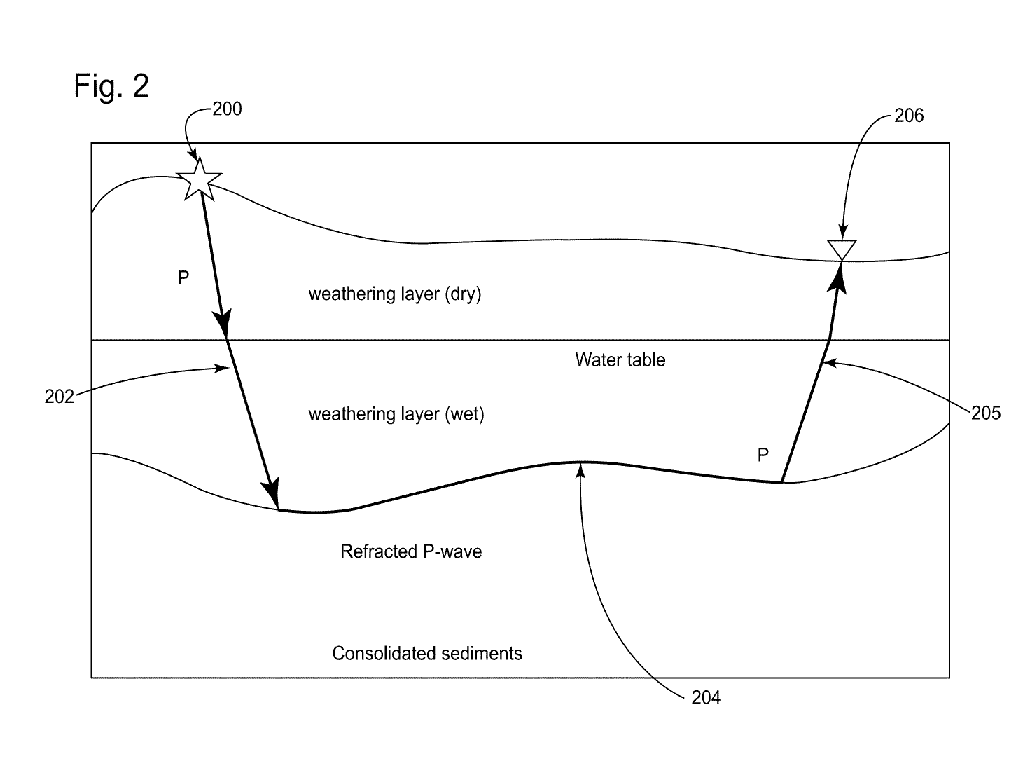

To better appreciate some of the near surface effects associated with seismic surveying consider now FIG. 2. Therein, a two-dimensional schematic of a refracted P-wave is illustrated. A source or shot 200 generates a downgoing P-wave 202 which passes through a weathering layer. If the weathering layer is a lower velocity media for elastic waves than the consolidated sediments layer, which is beneath the weathering layer in this example, then beyond the critical angle a head-wave (refracted P-wave) 204 is generated which propagates at the velocity of the deeper layer. The P-wave 205 returns to the surface and is detected by the receiver 206.

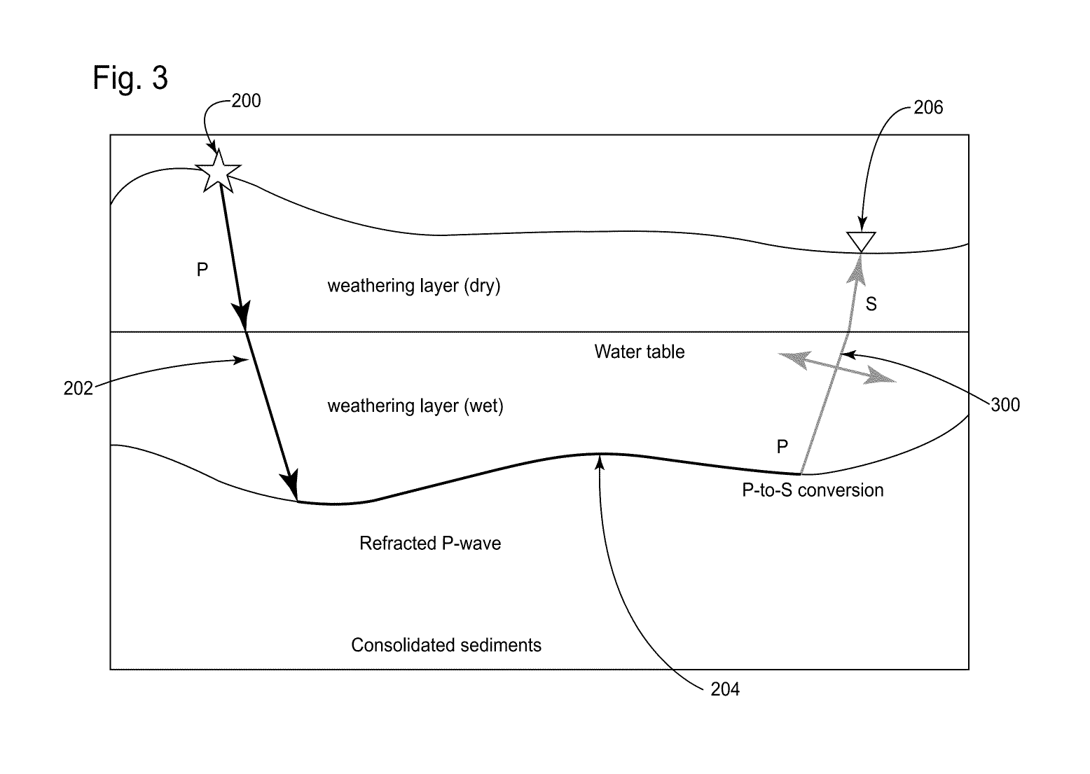

As shown in FIG. 3, the refracted P-wave 204 may also generate an upgoing S-wave 300 through P-to-S mode conversion at the interface between the consolidated sediments layer and the weathering layer. If the weathering layer is azimuthally isotropic then the upgoing S-wave 300 will be an SV-wave, i.e., an elastic wave for which the displacement vector is tangent to the wavefront in the plane containing the source 200 and receiver 206.

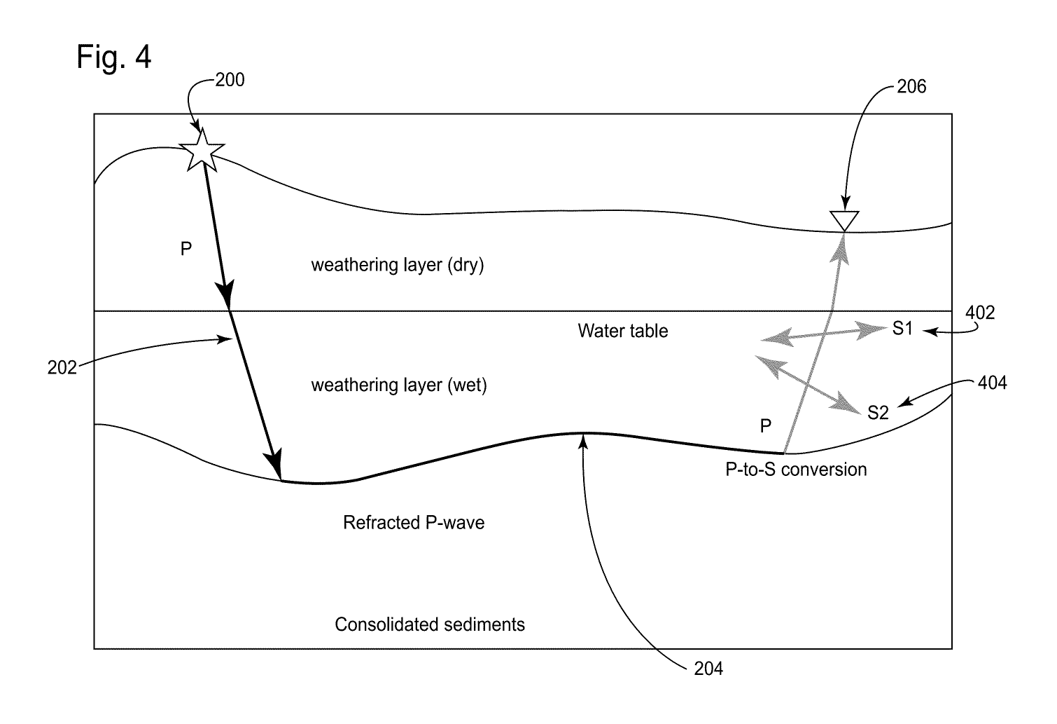

Alternatively, if the weathering layer is azimuthally anisotropic, then the S-wave 300 generated by the P-wave refraction 204 and mode conversion will split into two shear waves. Specifically, as shown in FIG. 4, a fast shear-wave S1 402, which is polarized parallel to the natural coordinate system, and a slow shear-wave S2 404, having a polarization orthogonal to the fast shear wave 402.

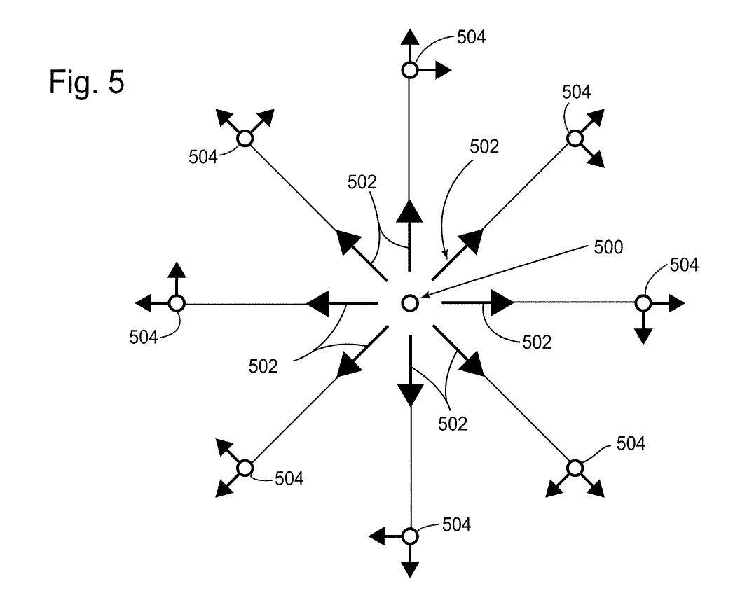

FIG. 5 illustrates some of the consequences of this wave splitting in the context of seismic surveying, portraying a two-dimensional schematic of a model shear-wave acquisition geometry in map or plan view. At the center of the model is the S-wave source 500, i.e., in this case the source is the mode-converted refracted P-wave. The source 500 generates SV-waves 502 in all directions. Eight, two-component, horizontal detectors 504 are illustrated oriented radially and tangentially to the source 500, and are placed in FIG. 5 for schematic convenience at a constant distance from the source 500, albeit this is not required. In an azimuthally isotropic medium the SV-wave will continue to the detectors 504 unchanged.

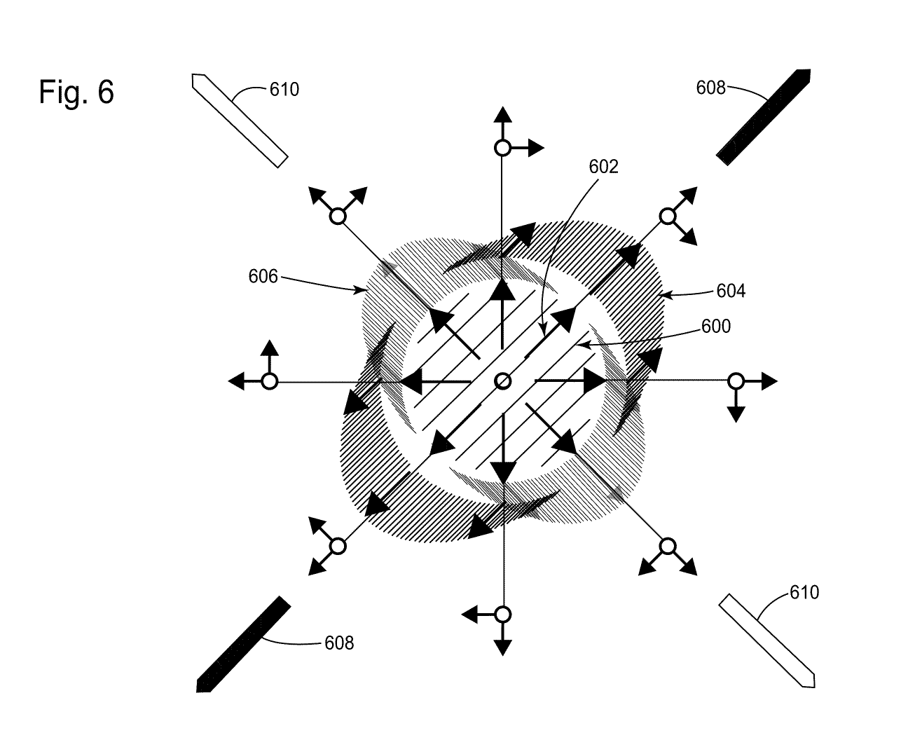

However the case of interest for these embodiments is the case where the medium being imaged is anisotropic, e.g., azimuthally anisotropic. Azimuthal anisotropy is determined by the natural geological coordinate system, which is in turn defined by some characteristic of the rock; for convenience it is here attributed to fractures 600, looking now to FIG. 6. When one of the radially-oriented SV-waves 602 encounters this azimuthally anisotropic medium it splits into fast 604 and slow 606 shear-waves. The fast shear-wave 604 is oriented parallel to the fractures 602 and experiences only the isotropic matrix. The slow shear-wave 606 is perpendicular to the fractures 602 and has a more tortuous travel path across them. For reference, the symmetry planes of the natural coordinate system are shown, i.e., the isotropy plane 608 and the symmetry-axis plane 610.

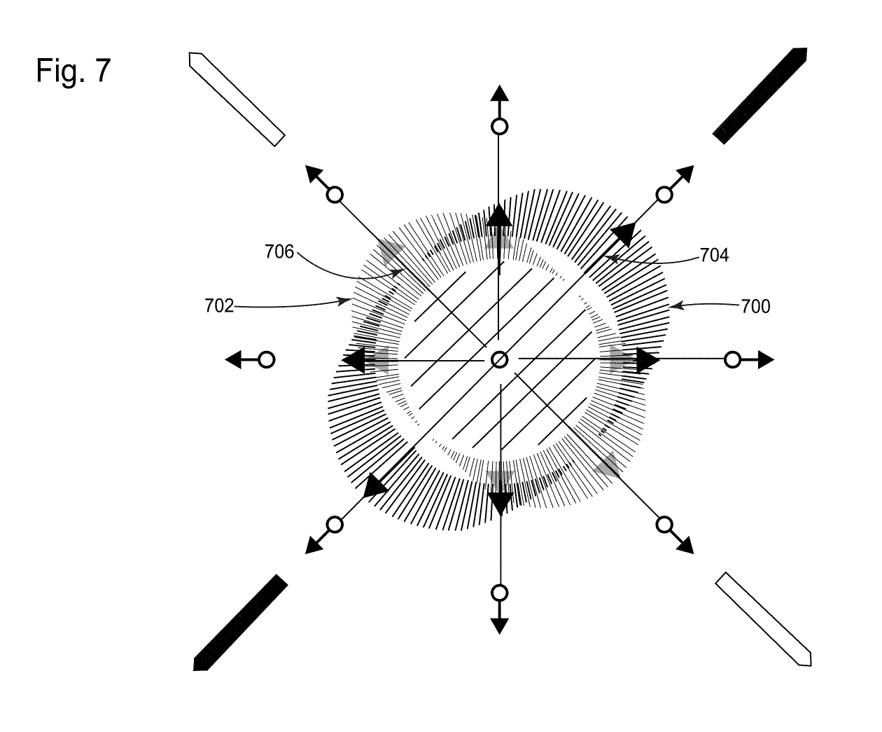

Turning now to FIG. 7, and since azimuthal isotropy is the initial assumption, the data are first examined on the radial and transverse receiver components, with the radial shown here. The radial receiver captures the radial projection of the signal amplitude at each azimuth. There is an azimuthal variation in the amplitude and arrival time of the fast shear-wave 700 and the slow shear-wave 702, with the amplitude indicated by the length of the vectors, e.g., vectors 704 and 706. The polarity of the signal is consistent for all azimuths, as indicated by the orientation of the arrows, e.g., vectors 704 and 706.

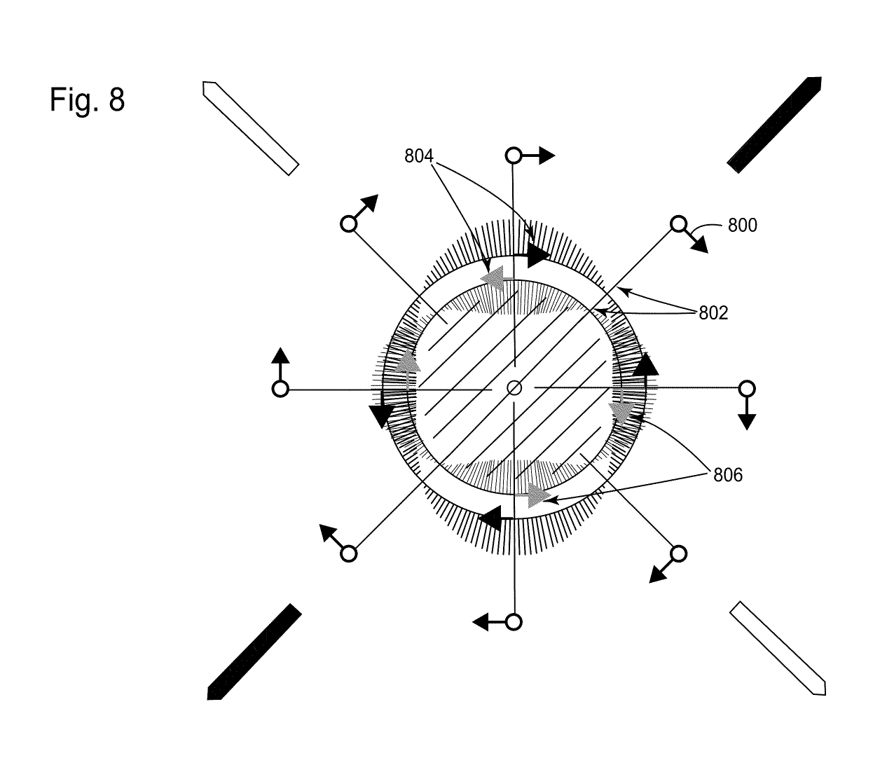

However, and now referring to FIG. 8, the projection of the signal amplitudes associated with the shear waves on the transverse component of the receiver or detector has a distinctly different character. In FIG. 8, the transverse component is represented by arrow 800 being perpendicular to the direction of the similar arrows in FIG. 7. For example, in the symmetry planes, where there is no observed splitting, the amplitude drops to zero on the transverse component 802. At any intermediate azimuth the fast and slow shear-waves are equal in amplitude and opposite in polarity as shown by arrows 804. Further, across the symmetry planes the polarity of both shear-waves reverses as shown by arrows 806.

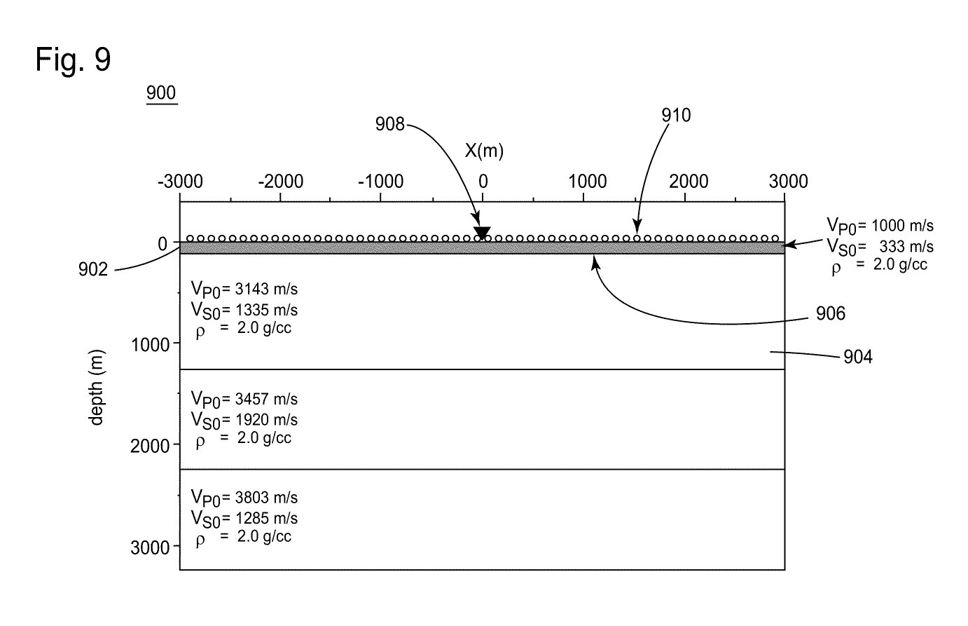

With this context regarding shear waves and how they are detected by multi-component detectors in seismic data acquisition systems, the discussion now turns to illustrating how such waves impact the imaged data using a synthetic data example. FIG. 9 illustrates a cross-section 900 of a depth model used to create the synthetic example. The purely illustrative model is 6000 meters across and 3250 meters deep. There are four layers, however it is the shallow 100 meter thick weathering layer 902 that is of particular interest. As illustrated, the P-wave velocity (V_{P0}) in the weathering layer is 1000 m/s and the S-wave velocity (V_{S0}) is 333 m/s. Both velocities are significantly lower than the corresponding velocities in the layer 904 beneath the weathering layer 902, making the interface 906 between layers 902 and 904 the refractor of interest. At the surface, a single receiver 908 is shown as a triangle, and sources 910, spaced at 100 meter intervals, are shown as circles.

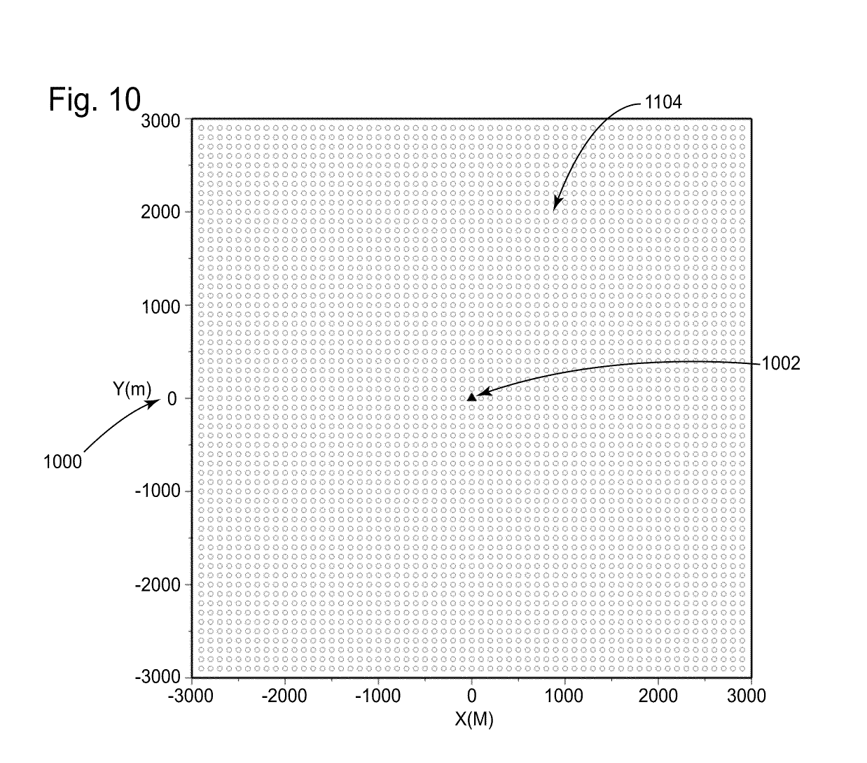

FIG. 10 illustrates a top view of the source and receiver acquisition geometry for this synthetic data example, 6000 meters on each side. Spatially, the cross-section shown in FIG. 10 represents a line 1000 at Y=0, parallel to the X-axis. The single receiver 1002 is shown as a black triangle, and the multiplicity of source points are illustrated as white circles, one of which is referred to by reference numeral 1004.

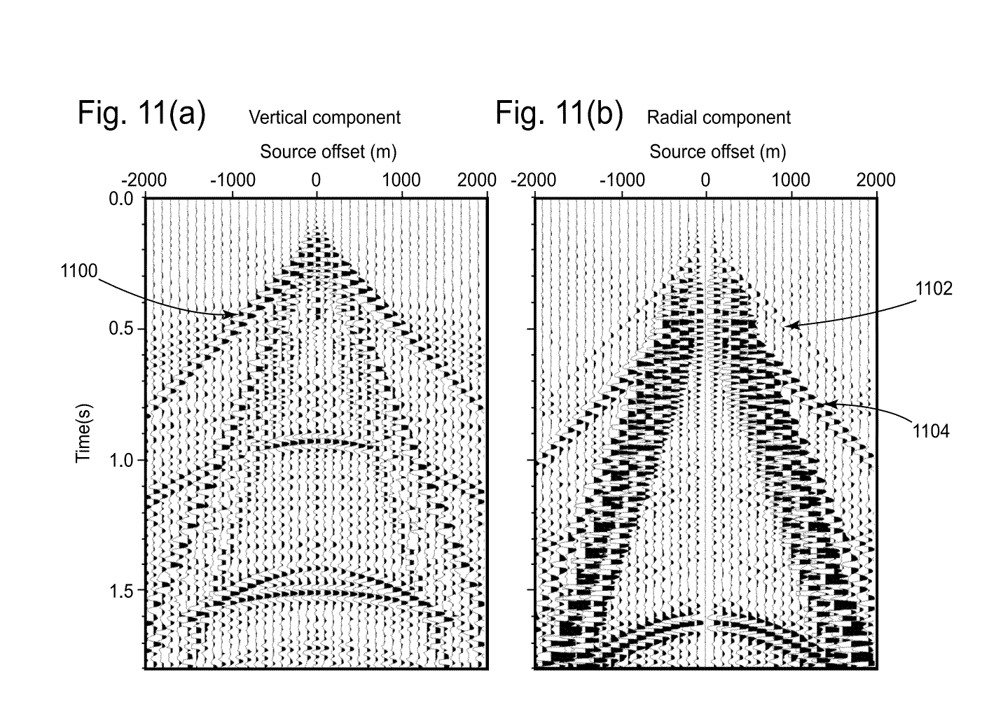

Synthetic seismic data were generated for the full 3D geometry shown in FIGS. 9 and 10, using a reflectivity method described, for example, in an article to Mallick, S. and Frazer, L. N., entitled “Computation of synthetic seismograms for stratified azimuthally anisotropic media”, in J. Geophys. Res., 86:359-377 (1990). The seismic data are illustrated for just the single cross-section taken across line 1000 in FIG. 10, although those skilled in the art will appreciate that other such cross-sections could be taken and illustrated as well. FIGS. 11(a) and 11(b) show the results of plotted traces for this cross-section if the layers in FIG. 9 are isotropic. Specifically, the P-wave refraction is shown on the vertical receiver component 1100 in FIG. 11(a) and its projection on the radial receiver component 1102 is shown in FIG. 11(b). The shear-wave created through mode-conversion of the P-wave refraction is also shown on the radial receiver component at 1104. The transverse receiver component (not shown) contains no data due to the isotropic nature of the layers.

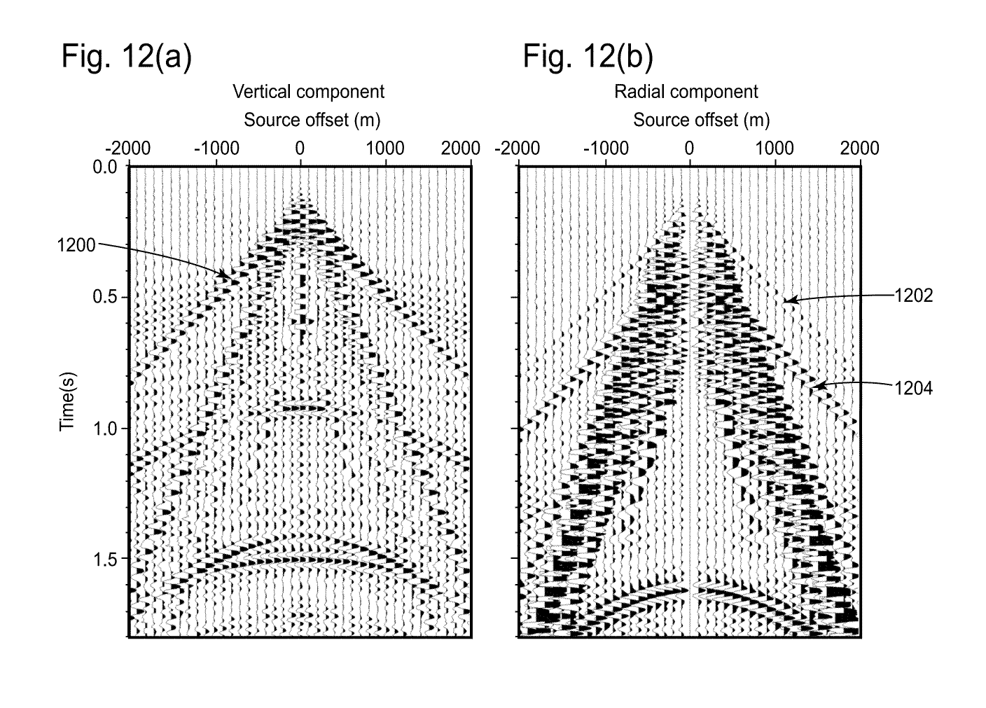

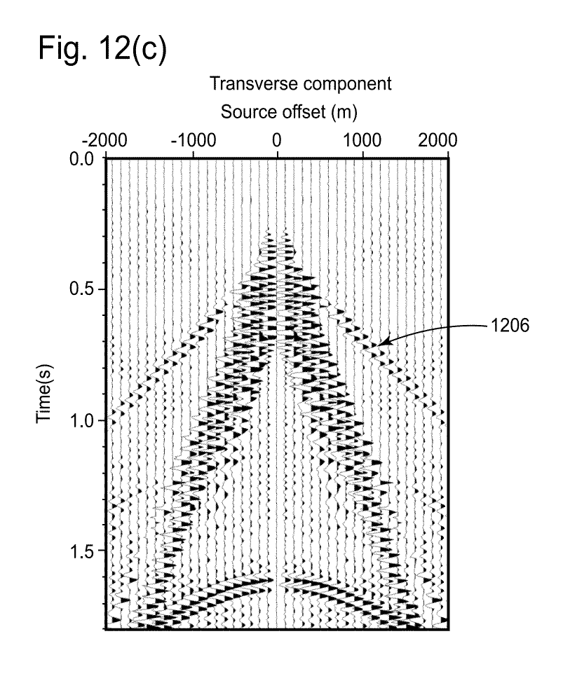

Referring now to the cross-sections of FIGS. 12(a)-12(c), the model in FIG. 9 is now changed by adding 4% azimuthal anisotropy in the first layer only, with the isotropy plane (the fast direction) oriented N135° E. Since this cross-section represents a single azimuthal slice through the data volume, the impact of the anisotropy is visible largely through travel-time differences on the vertical and radial components. As with the isotropic example described above with respect to FIG. 11(a), the P-wave refraction is shown on the vertical receiver component 1200 in FIG. 12(a) and its projection 1202 on the radial receiver component is shown in FIG. 12(b). The shear-wave created through mode-conversion of the P-wave refraction is also shown on the radial receiver component at 1204 in FIG. 12(b).

Since the model is now azimuthally anisotropic, the transverse component output from the receivers is no longer zero. Accordingly, the traces associated with the cross-section taken across line 1000 are also shown in FIG. 12(c) for the transverse component. Therein, it can be seen that the mode-converted P-wave refraction is visible on the transverse receiver at 1206.

The comparison between the results shown in FIGS. 11(a)-11(c) (for shear waves passing through an isotropic media) and the results shown in FIGS. 12(a)-12(c) (for shear waves passing through an anisotropic media) becomes clearer after (optionally) applying linear moveout to the synthetic trace data. As will be appreciated by those skilled in the art, linear moveout refers to a data processing step which can be applied to acquired seismic data to convert events which have a stepout (time lag) that is a linear function of distance into horizontal events. This is convenient for analysis because the window selected for analysis may have reduced spatial variation.

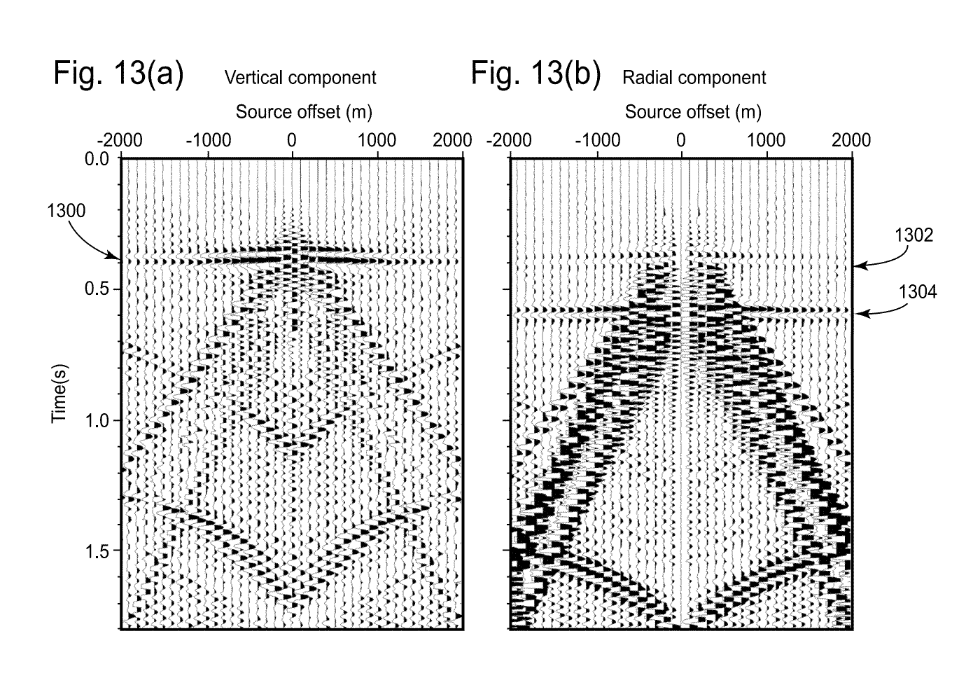

Returning to the azimuthally isotropic example of FIGS. 11(a)-11(b), FIGS. 13(a)-13(b) show the same data after applying linear moveout thereto. More specifically, the P-wave refraction has been flattened by applying a linear moveout using the P-wave velocity of the second layer (i.e., 3143 m/s in this purely illustrative example). The P-wave refraction at the base of the weathering layer is now prominent on the vertical receiver component as generally shown by reference numeral 1300, as is its projection on the radial receiver component as generally shown by reference numeral 1302. The mode-converted shear-wave is parallel to the P-wave refraction, and arrives 200 milliseconds later on the radial receiver component at 1304. Since this is the isotropic example, the transverse receiver component contains no energy and is not shown.

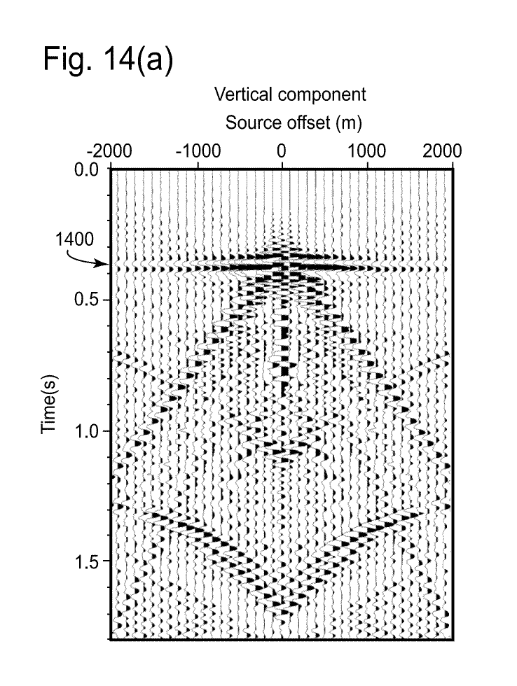

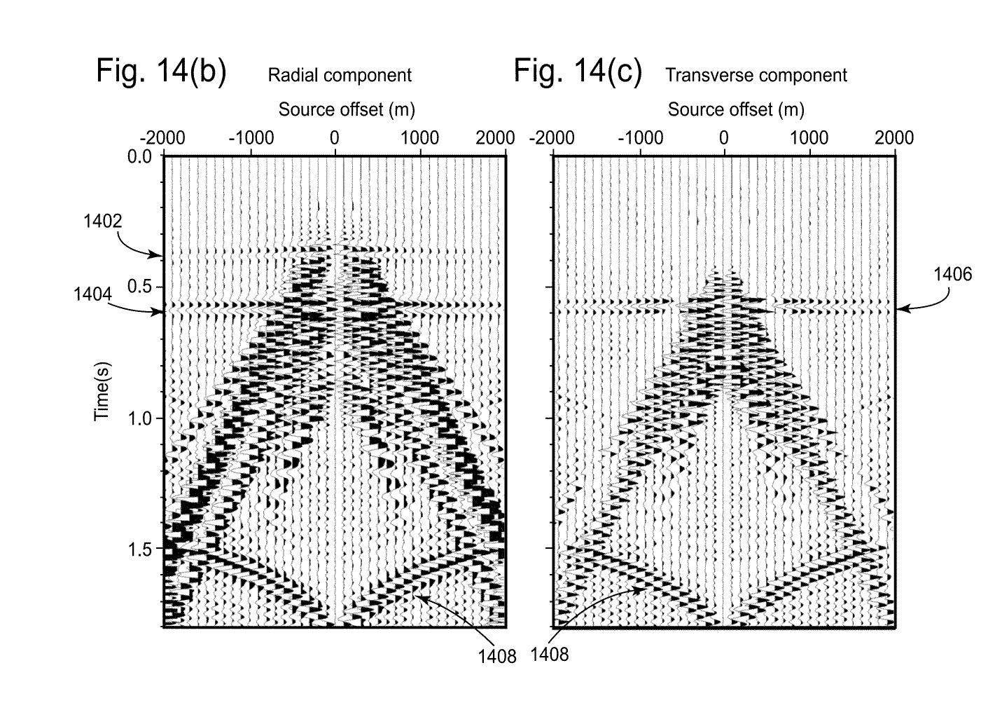

Applying the same linear moveout to the azimuthally anisotropic data of FIGS. 12(a)-12(c), a similar result is obtained, differing slightly in travel-time and signal amplitudes as shown in corresponding FIGS. 14(a)-14(c). Again, the P-wave refraction is shown on the vertical receiver component at 1400 in FIG. 14(a) and its projection on the radial receiver component is shown at 1402 in FIG. 14(b). The shear-wave created through mode-conversion of the P-wave refraction is also shown on the radial receiver component at 1404. Looking also at the data on the transverse component (shown FIG. 14(c)) the mode-converted shear-wave 1406 can be clearly identified.

Comparing the radial receiver component of FIG. 14(b) with the transverse receiver component of FIG. 14(c) illustrates the impact of the shallow anisotropy on the shear-waves in this synthetic data example. Recall that for the azimuthally isotropic example there is no signal energy on the transverse component. The impact of the anisotropy on the shear-wave is apparent by the presence of the mode-converted head-wave on the transverse component at 1406. Note also that the later arriving PS-wave, converted from a deeper reflector, is seen on both the radial and transverse receiver components at 1408 because of the shallow anisotropy.

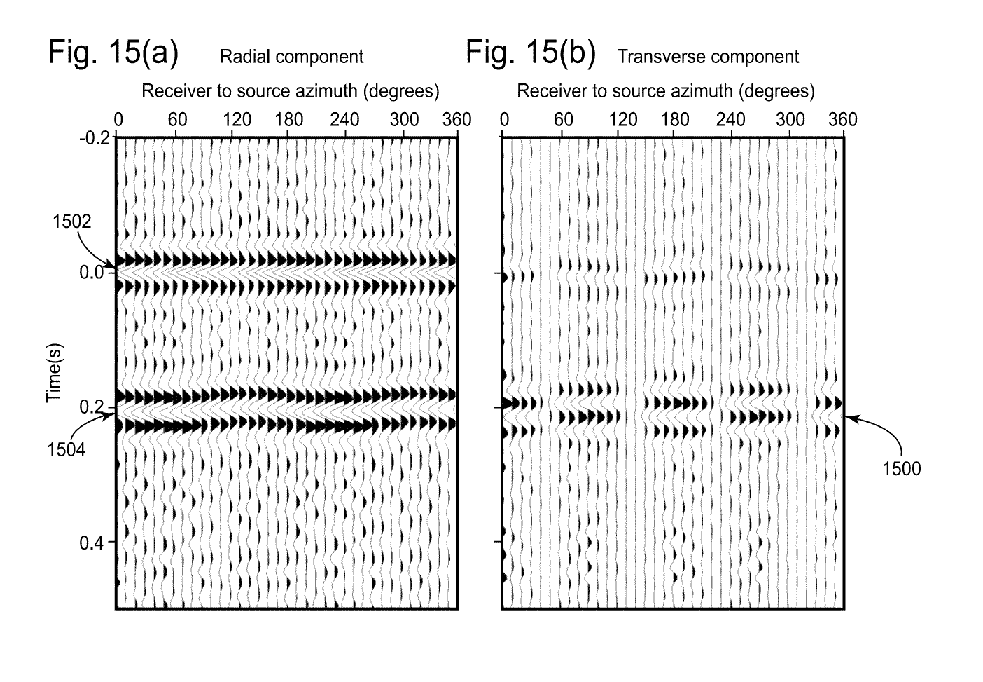

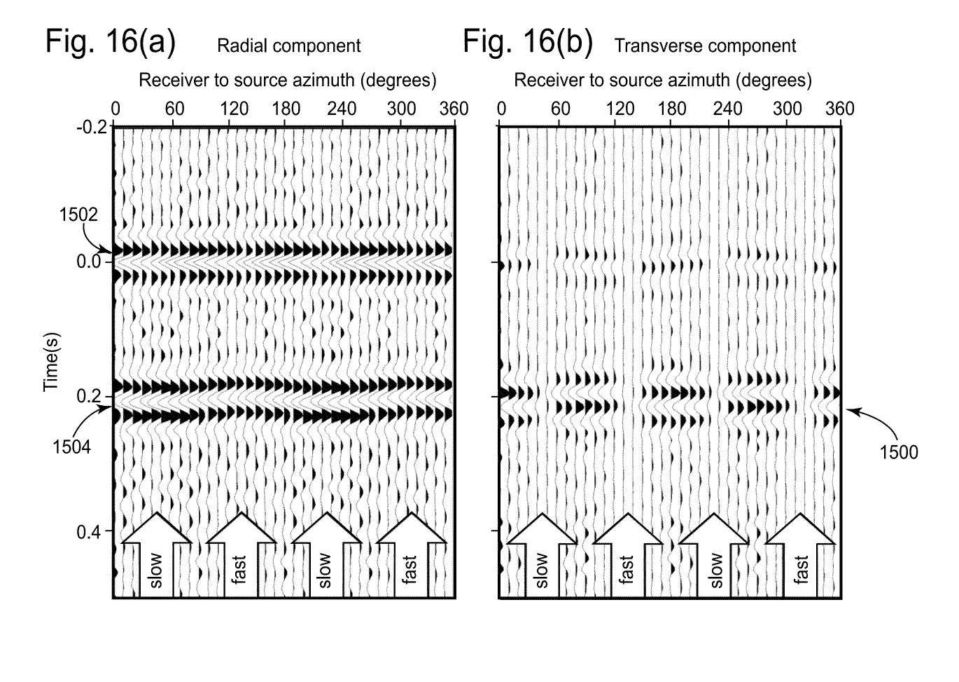

The embodiments described herein leverage the different results obtained above for the isotropic case versus the anisotropic case to help identify the characteristics of shear waves generated during seismic acquisition in anisotropic media. Specifically, embodiments perform cross-correlations of the radial receiver component with the vertical receiver component (an example of which is illustrated in FIG. 15(a) for the synthetic data example above) and of the transverse receiver component with the vertical receiver component (an example of which is illustrated in FIG. 15(b) for the synthetic data example), for all source points, e.g., source points 1004 shown in FIG. 10. These cross-correlations are sometimes referred to herein as the “radial receiver function” and the “transverse receiver function”. The results shown in FIGS. 15(a) and 15(b) are substacked and displayed in 10-degree azimuth sectors for the case described above wherein the shallow layer being imaged has a 4% azimuthal anisotropy.

From the results in FIGS. 15(a) and 15(b), it can be seen that, by performing the afore-described cross-correlations according to embodiments, the azimuthal characteristics of the shear wave(s) present in the data can be identified, i.e., those characteristics described above with respect to FIGS. 7 and 8. That is, the transverse receiver component cross-correlation in FIG. 15(b) has nulls (i.e., zero response) in the symmetry planes at 45°, 135°, 225° and 315°, separating polarity reversals as shown in FIG. 15(b) across the area 1500 in the plot. Moreover, the radial component cross-correlation in FIG. 15(a) shows a flat P-wave arrival at zero lag 1502 and a clear azimuthal variation in the shear-wave travel-time 1504 with the fast arrival oriented at 135° and 315°.

More specifically, these observations can be used to determine the orientation of the fast shear wave and/or the magnitude of the slow shear wave by valuating data from the transverse component using changes in polarity with azimuth, or variations in amplitude with azimuth, as criteria. An example of a polarity-based method for accomplishing this task is the so-called polarity flip filter method, and an example of an amplitude-based method is a least-squares fit to the amplitude of the transverse components. As will be appreciated by those skilled in the art, other techniques can also be used that are not limited to the use of the transverse component including an Alford-rotation analysis method or a 45 degree geometry analysis. For the reader interested in more detail regarding the algorithms described in this paragraph, reference is made to the following articles: Haacke, R., 2013, “High-precision estimation of split PS-wave time delays and polarization directions”, Geophysics, Vol. 78, No. 2, P. V63-V77, Bale, R. A., J. Li, B. Mattocks, and S. Ronen, 2005, “Robust estimation of fracture directions from 3-D converted waves”, 75th SEG Annual Meeting, Expanded Abstracts, 889-892, and Gaiser, J., 1999, “Enhanced PS-wave images and attributes using prestack azimuth processing”, 69th SEG Annual Meeting, 699-702, each of which is incorporated here by reference.

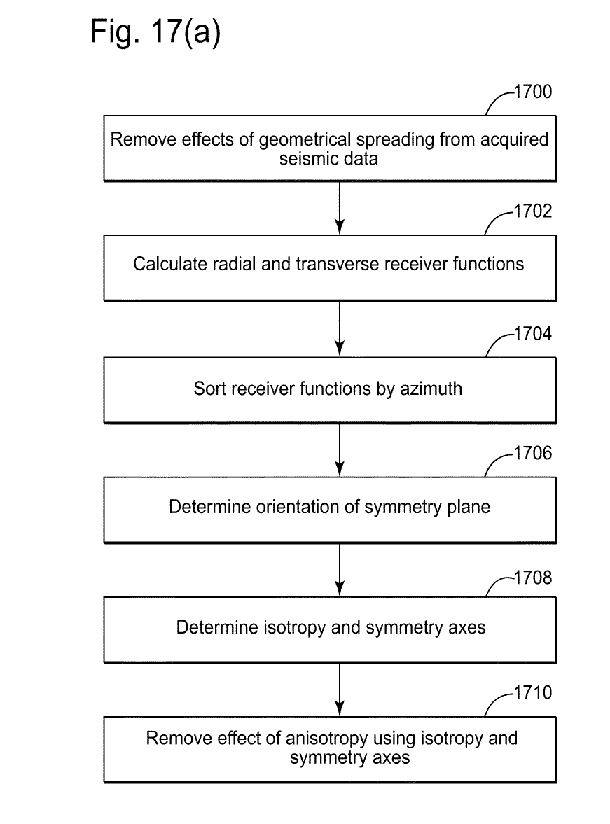

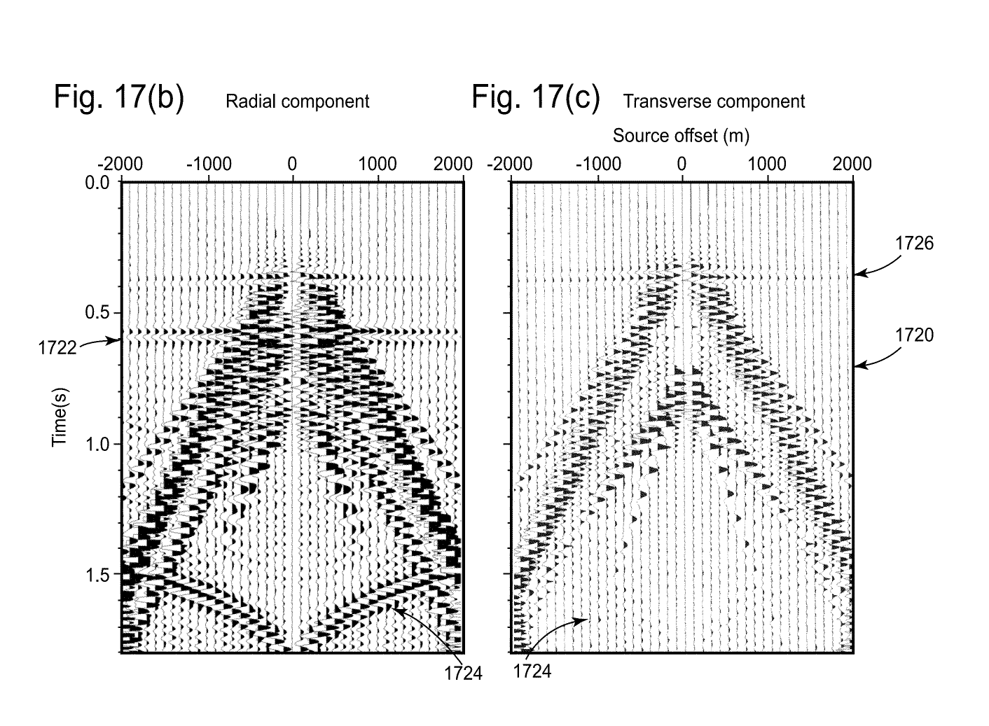

Thus embodiments described herein use receiver functions, e.g., cross correlations calculated on both the radial and transverse receiver components as described above, to identify anisotropic characteristics associated with, e.g., shallow layer mode conversion of seismic waves. Once identified, the seismic data can then be further processed to compensate for such effects, e.g., removing them, using any known technique, to better enable seismic data processing techniques to image deeper reflectors in the subsurface. An exemplary method embodiment will now be described with respect to FIG. 17 (a).

Therein, at step 1700, and for a three-component common receiver gather, the effects of geometrical spreading are removed. This may be accomplished by, for example, conventional geometrical spreading correction applied identically to all three components, or the data may be scaled using an alternative vector scaling method. Another method for performing this step is to calculate the direction cosines of the three-component data at each sample.

At step 1702, receiver functions from the vertical and radial components of the common receiver gather, and from the vertical and transverse components, are calculated. The receiver function is calculated according to one embodiment through cross-correlation of the two components in a time window encompassing the first arriving compressional (P) headwave and corresponding mode-converted shear (PPS) wave. At step 1704, and for each component, the receiver functions are sorted by azimuth. The data may, optionally, be substacked within azimuth sectors.

Using the transverse receiver function, the orientation of the symmetry plane of the HTI (horizontal transverse isotropy) system is determined at step 1706. This determination step can be based on variations in the amplitude and polarity of the signal with azimuth, e.g., using various well-known methods for accomplishing this, as applied to conventional converted shear-wave data. At step 1708, given the symmetry orientation determined above, assume that one axis represents the isotropy plane and that the other axis represents the symmetry-axis plane. Then, using the radial receiver function component, the data with azimuths near the assumed symmetry-axis plane is cross-correlated against data with azimuths near the assumed isotropy plane. If the estimated delays are negative, swap the assumed azimuths of the symmetry-axis and isotropy plane. Then, at step 1710, the orientation of the fast shear-wave (the isotropy axis) and measured lag of the slow shear-wave (symmetry-axis) can be used to remove the effect of azimuthal anisotropy in the near-surface in the original data at this receiver location, as though the data were acquired over an isotropic near-surface.

One technique for performing step 1710 to remove the anisotropy, once the anisotropy has been identified in the manner described above in these embodiments, is provided in, for example, the article to Bale, R., B. Gratacos, B. Mattocks, S. Roche, K. Poplayskii, and X. Li, 2009, entitled “Shear wave splitting applications for fracture analysis and improved imaging: some onshore examples”, First Break, Vol. 27, September 2009, the disclosure of which is incorporated here by reference. Briefly, the basic steps for removing anisotropy at step 1710 can include the following steps. First, rotating the data from the radial-transverse coordinate system into the anisotropic coordinate system (referred to here as P-S1 and P-S2, where S1 is the fast shear-wave aligned with the isotropy axis, and S2 is the slow shear-wave aligned with the symmetry axis). Second, determining the shift (the amount of anisotropy) by cross-correlating the P-S2 traces with the P-S1 traces. Third, applying the shift to the P-S2 traces. This latter step aligns the P-S2 traces with the P-S1 traces and can be applied as a gradually-accumulating time-shift in the time window over which the anisotropy accumulates, but for the first layer (such as layer 902 illustrated in FIG. 9) it can be applied to an entire trace. Then, the data can be rotated back to the radial-transverse coordinate system. By performing these substeps, for example, as step 1710, the effect of the anisotropy has been removed from (or reconciled in) the acquired seismic data.

The results of the method of FIG. 17(a) can also be seen in FIGS. 17(b) and 17(c). Therein, the split mode-converted head-wave 1720 has been removed from the transverse component and incorporated into the radial component at 1722. The split mode-converted PS-wave reflection 1724 has also been removed from the transverse component and incorporated into the radial component. The data remaining on the transverse component after this removal procedure consist of noise, not shear-wave signal, including the P head-wave 1726.

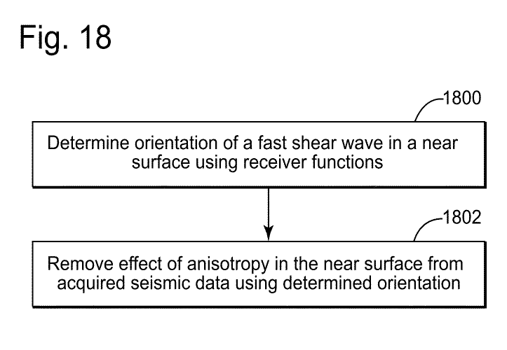

The method of FIG. 17(a) can also be further generalized according to other embodiments. For example, as shown in FIG. 18, receiver functions of the radial and transverse components of a three component receiver gather are used to determine the orientation of the fast shear-wave in the near-surface, and the corresponding magnitude of the lag of the slow shear-wave at step 1800. This information can then be used to remove at step 1802 the effect of azimuthal shear-wave anisotropy in the near-surface.

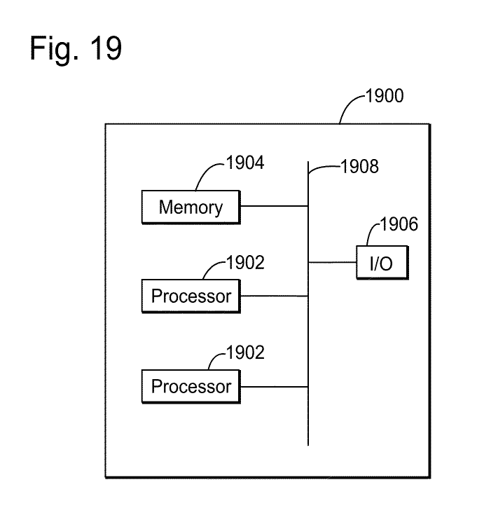

An example of a representative computing system capable of carrying out operations in accordance with these embodiments is very generally illustrated in FIG. 19. System 1900 includes, among other items, one or more processors 1902, a memory device 1904, and an input/output (I/O) unit 1906, all of which are interconnected by bus 1908.

System 1900 can be used to implement the methods described above associated with the determination of shear wave characteristics associated with shear waves propagating through an anisotropic layer and/or removal of the effects of such shear waves. Hardware, firmware, software or a combination thereof may be used to perform the various steps and operations described herein. It should be noted in the embodiments described herein that these techniques can be applied in either an “offline”, e.g., at a land-based data processing center or an “online” manner, i.e., in near real time while seismic acquisition is being performed.

The disclosed exemplary embodiments provide systems and methods for shallow shear-wave splitting analysis using receiver functions associated with seismic images. It should be understood that this description is not intended to limit the invention. On the contrary, the exemplary embodiments are intended to cover alternatives, modifications and equivalents, which are included in the spirit and scope of the invention. Further, in the detailed description of the exemplary embodiments, numerous specific details are set forth in order to provide a comprehensive understanding of the invention. However, one skilled in the art would understand that various embodiments may be practiced without such specific details.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

What is claimed is:

1. A method for removing one or more effects, associated with anisotropy in a near surface layer, in acquired seismic data comprising:
determining an orientation of a fast shear wave in the near surface using receiver functions; and
removing the one or more effects associated with anisotropy in the near surface layer using the determined orientation.

2. The method of claim 1, wherein determining further comprises:
calculating a radial receiver function and a transverse receiver function.

3. The method of claim 2, wherein the radial receiver function is a cross-correlation between radial component data and vertical component data, and the transverse receiver function is a cross-correlation between transverse component data and the vertical component data.

4. The method of claim 1, further comprising:
removing effects of geometrical spreading from the acquired seismic data.

5. The method of claim 1, further comprising:
sorting the receiver functions by azimuth.

6. The method of claim 1, wherein the orientation of the fast shear wave is determined based upon nulls observed in a transverse receiver function and traveltime variation in a radial receiver function.

7. The method of claim 1, wherein the anisotropy in the near surface layer is azimuthal anisotropy.

8. The method of claim 1, wherein the step of removing further comprises:
rotating the acquired data from a radial-transverse coordinate system to an anisotropic coordinate system based on the determined orientation;
determining an amount of anisotropic shift by cross-correlating fast shear wave traces with a slow shear wave traces associated with the rotated data;
applying the amount of anisotropic shift to the slow shear wave traces to output compensated seismic data; and
rotating the compensated seismic data back to the radial-transverse coordinate system.

9. A method for determining characteristics of fast and slow shear waves propagating through an anisotropic layer comprising:
removing effects of geometrical spreading in acquired seismic data;
calculating radial and transverse receiver functions using the acquired seismic data;
sorting the radial and transverse receiver functions by azimuth;
determining an orientation of a symmetry plane associated with a fast shear wave; and
determining an isotropy axis and a symmetry axis based upon the orientation.

10. A system for removing one or more effects, associated with anisotropy in a near surface layer, in acquired seismic data comprising:
at least one processor configured to determine an orientation of a fast shear wave in the near surface using receiver functions; and to remove the one or more effects associated with anisotropy in the near surface layer using the determined orientation.

11. The system of claim 10, wherein the at least one processor is further configured to calculate a radial receiver function and a transverse receiver function.

12. The system of claim 11, wherein the radial receiver function is a cross-correlation between radial component data and vertical component data, and the transverse receiver function is a cross-correlation between transverse component data and the vertical component data.

13. The system of claim 10, wherein the at least one processor is further configured to remove effects of geometrical spreading from the acquired seismic data.

14. The system of claim 10, wherein the at least one processor is further configured to sort the receiver functions by azimuth.

15. The system of claim 10, wherein the at least one processor is further configured to determine the orientation of the fast shear wave based upon nulls observed in a transverse receiver function and traveltime variation in a radial receiver function.

16. The system of claim 10, wherein the anisotropy in the near surface layer is azimuthal anisotropy.

17. The system of claim 10, wherein the at least one processor is further configured to remove the one or more effects associated with anisotropy by
rotating the acquired data from a radial-transverse coordinate system to an anisotropic coordinate system based on the determined orientation;
determining an amount of anisotropic shift by cross-correlating fast shear wave traces with a slow shear wave traces associated with the rotated data;
applying the amount of anisotropic shift to the slow shear wave traces to output compensated seismic data; and
rotating the compensated seismic data back to the radial-transverse coordinate system.

18. The system of claim 10, wherein the acquired seismic data is acquired using receivers having at least three sensing components.

19. The method of claim 1, wherein the acquired seismic data is acquired using receivers having at least three sensing components.

20. The method of claim 9, further comprising the step of:
removing an effect of anisotropy using the isotropy axis and the symmetry axis.
